(19) United States
(12) Patent Application Publication
(10) Pub. No.: US 2020/0076027 A1
(43) Pub. Date: Mar. 5, 2020

(54) COOLING DUCTS FOR BATTERIES

(71) Applicant: Trojan Battery Company, LLC, Santa Fe Springs, CA (US)

(72) Inventor: Jesus Florencio Perez LOPEZ, Santa Fe Springs, CA (US)

(73) Assignee: Trojan Battery Company, LLC, Santa Fe Springs, CA (US)

(21) Appl. No.: 16/560,185

(22) Filed: Sep. 4, 2019

Related U.S. Application Data
(60) Provisional application No. 62/726,900, filed on Sep. 4, 2018.

(51) Int. Cl. H01M 10/6556; H01M 10/613; H01M 10/6568; H01M 10/18

(52) U.S. Cl. CPC H01M 10/6556; H01M 10/18; H01M 10/6568; H01M 10/613

(57) ABSTRACT

A bipolar plate includes a first conductive plate and a second conductive plate. The bipolar plate further includes a substrate between the first and second conductive plates. The bipolar plate further includes a plurality of cooling ducts extending from the first conductive plate, through the substrate, and to the second conductive plate. The cooling ducts are configured to permit the flow of a cooling liquid. The bipolar plate may be used in the assembly of a battery, such as a lead-acid battery or other suitable battery.

### FIELD

The present disclosure generally relates to bipolar plates for batteries, such as lead-acid batteries or other suitable batteries.

### BACKGROUND

It has been observed that, during the formation process in batteries, the battery temperature increases. One approach to mitigate temperature increases during formation is to conduct the formation step in a cold water bath. This keeps cold water in contact with the exterior walls of the battery but does not allow the cold water to travel through the battery, thereby cooling the battery from the outside.

### SUMMARY

The following presents a simplified summary of one or more aspects of the present disclosure in order to provide a basic understanding of such aspects. This summary is not an extensive overview of all contemplated aspects and is intended to neither identify key or critical elements of all aspects nor delineate the scope of any or all aspects. Its purpose is to present some concepts of one or more aspects in a simplified form as a prelude to the more detailed description that is presented later.

Aspects of the present disclosure are directed to a bipolar plate, comprising: first and second conductive plates; and a substrate between the first and second conductive plates, the bipolar plate having a plurality of cooling ducts extending from the first conductive plate, through the substrate, to the second conductive plate. The cooling ducts permit the flow of a cooling liquid, such as cold water, through them. The bipolar plates may be used in the assembly of a battery, such as a lead-acid battery or other suitable battery.

These and other aspects of the invention will become more fully understood upon a review of the detailed description, which follows.

### BRIEF DESCRIPTION OF THE DRAWINGS

These and other features of the devices and methods provided herein will be more fully disclosed in, or rendered obvious by, the following detailed description of the preferred embodiments, which is to be considered together with the accompanying drawings wherein like numbers refer to like parts and further wherein:

FIG. 1 shows a side perspective view of a bipolar plate according to some exemplary embodiments of bipolar plates.

FIG. 2 shows a front view of the bipolar plate shown in FIG. 1.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known components are shown in block diagram form in order to avoid obscuring such concepts.

Battery temperature during formation may be controlled via cooling ducts through the battery, such as through bipolar plates in the battery. Cooling ducts allow cold water to flow through the battery during formation to dissipate heat and maintain temperature control of the formation process. Adding cooling ducts to the battery will also accelerate the formation process and dissipate heat more quickly.

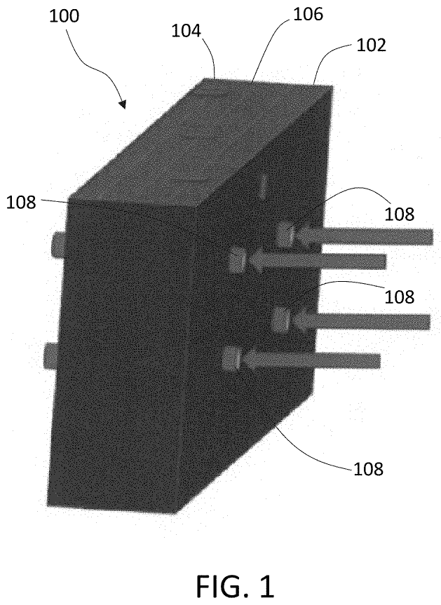

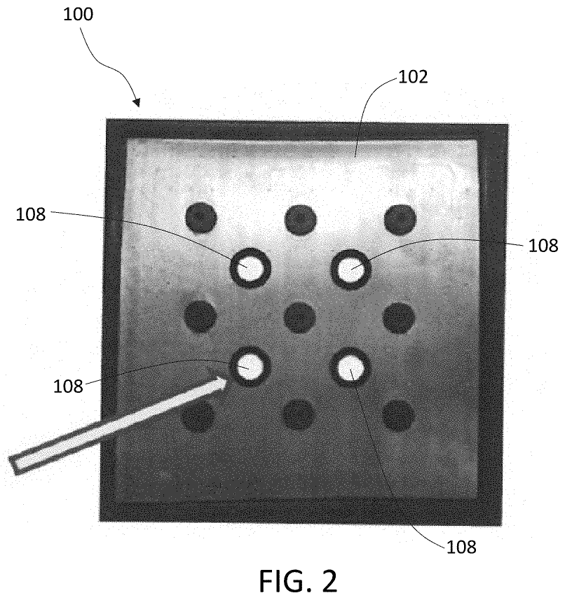

FIGS. 1 and 2 show side and front views, respectively, of a bipolar plate according to some exemplary embodiments of bipolar plates. The bipolar plate 100 includes a first conductive plate 102 and a second conductive plate 104. The bipolar plate 100 further includes a substrate 106 disposed between the first 102 and second 104 conductive plates. The bipolar plate 100 further includes one or more cooling ducts 108 extending from the first conductive plate 102, through the substrate 106, and to the second conductive plate 104. The cooling ducts 108 are configured to permit the flow of a cooling liquid therethrough (as illustrated by the solid arrows in FIG. 1). The cooling liquid may be used to cool the bipolar plate 100 during the assembly of a battery, such as a lead-acid battery.

The cooling ducts 108 may be created using any suitable means known in the art for creating ducts through plates, including but not limited to drilling or punching holes in the bipolar plate 100. The cooling ducts 108 may be created before or after assembly of the first 102 and second 104 conductive plates and the substrate 106 into a bipolar plate.

The cooling ducts 108 may be used in bipolar plates of any type of battery, such as lead-acid batteries or other suitable batteries. The shape and dimensions (including length, width, and thickness) of the bipolar plates are not particularly limited. The first 102 and second 104 conductive plates and the substrate 106 may be of any suitable materials known in the art, and the first 102 and second 104 conductive plates may be joined to the substrate 106 by any suitable means known in the art.

The bipolar plate 100 may contain any number of cooling ducts 108, including but not limited to 1, 2, 3, 4, 5, 6, 7, 8, 9, or 10 cooling ducts. In some exemplary embodiments, the bipolar plate 100 contains 4 cooling ducts 108. The cooling ducts 108 may be of any shape or diameter and may be arranged in any pattern, and the shape, diameter, and/or pattern may be limited by the size and shape of the bipolar plate 100. The shape, diameter, size, pattern, and number of cooling ducts 108 in a bipolar plate 100 may be optimized, depending on such factors including but not limited to the dimensions and material composition of the bipolar plate 100, and the temperature excursions in battery assembly, formation, and use. Bipolar plates according to aspects of the present disclosure may be assembled into batteries, such as lead-acid batteries or other suitable batteries, using any suitable means known in the art.

The cooling ducts 108 may have a cooling liquid, such as cold water, run through them using any suitable means for lowering the temperature of the bipolar plate 100 or the assembled battery. Suitable means include, but are not limited to, water tubing running through the cooling ducts, or immersion in a water bath in the assembled battery including the bipolar plate 100.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims. Aspects from the various embodiments described, as well as other known equivalents for each such aspect, can be mixed and matched by one of ordinary skill in the art to construct additional embodiments and techniques in accordance with principles of this application.

While the aspects described herein have been described in conjunction with the example aspects outlined above, various alternatives, modifications, variations, improvements, and/or substantial equivalents, whether known or that are or may be presently unforeseen, may become apparent to those having at least ordinary skill in the art. Accordingly, the example aspects, as set forth above, are intended to be illustrative, not limiting. Various changes may be made without departing from the spirit and scope of the disclosure. Therefore, the disclosure is intended to embrace all known or later-developed alternatives, modifications, variations, improvements, and/or substantial equivalents.

Reference to an element in the singular is not intended to mean “one and only one” unless specifically so stated, but rather “one or more.” All structural and functional equivalents to the elements of the various aspects described throughout this disclosure that are known or later come to be known to those of ordinary skill in the art are expressly incorporated herein by reference. Moreover, nothing disclosed herein is intended to be dedicated to the public.

Further, the word “example” is used herein to mean “serving as an example, instance, or illustration.” Any aspect described herein as “example” is not necessarily to be construed as preferred or advantageous over other aspects.

What is claimed is:

1. A bipolar plate, comprising:
a first conductive plate;
a second conductive plate;
a substrate between the first and second conductive plates; and
a plurality of cooling ducts extending from the first conductive plate, through the substrate, and to the second conductive plate;
wherein the cooling ducts are configured to permit the flow of a cooling liquid.
